(19) United States
(12) Patent Application Publication
(10) Pub. No.: US 2005/0046075 A1
(43) Pub. Date: Mar. 3, 2005

(54) TWO SHOT MOLDING WITH SOFT BOLSTER OPTION

(75) Inventors: John D. Youngs, Southgate, MI (US); James Gregory, Harrison Township, MI (US); Mark Heinze, Clarkston, MI (US); John Slaven, Grosse Pointe Shores, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 10/604,902

(22) Filed: Aug. 26, 2003

(51) Int. Cl. B29C 45/14; B29C 45/16

(52) U.S. Cl. 264/255; 264/257; 264/279; 264/279.1; 425/129.1

(57) ABSTRACT

In accordance with the present invention, a preferred embodiment of a method for manufacturing a trim panel assembly is provided. A further aspect of the invention provides a method that includes a first tool having a mold element movable between a first position and a second position, the first tool producing a trim panel having a recess when the element is in the first position. A bolster, manufactured using a second tool, is secured within the recess.

### BACKGROUND OF INVENTION

The present invention relates to interior vehicle trim panels and more particularly to a device and method for manufacturing interior vehicle trim panels.

Interior trim panels are widely used to enhance the appearance of automobile passenger cabins to provide passengers with a more pleasing environment. To manufacture trim panels having two different colors or two different materials, a two shot molding process is traditionally used. Using the two shot molding process, the following types of trim panels may be manufactured: 1) a trim panel having two hard components of the same color; 2) a trim panel having two hard components of different colors; and 3) a trim panel having one hard component and one soft component. One example of a conventional two shot molding technique is disclosed in U.S. patent application Ser. No. 10/207,333 entitled “Method of Forming A Vehicle Trim Panel.” application Ser. No. 10/207,333 is incorporated by reference herein.

While conventional two shot molding tools and manufacturing processes perform adequately for their intended uses, such tools and processes are subject to improvement. Specifically, there is a need for a two shot molding tool and manufacturing process capable of producing a trim panel having a cloth or vinyl bolster. The present invention fulfills this need in the art.

### SUMMARY OF INVENTION

In accordance with the present invention, a preferred embodiment of a method for manufacturing a trim panel assembly is provided. A further aspect of the invention provides a method that includes a first tool having a mold element movable between a first position and a second position, the first tool producing a trim panel having a recess when the element is in the first position. A bolster, made using a second tool, is secured within the recess. An additional aspect of the invention provides for a system for manufacturing a trim panel assembly comprising a first tool and a second tool. When a mold element of the first tool is in a second position, the first tool produces a first trim component having a cavity. The second tool produces a second trim component that is secured within the cavity to form the trim panel assembly. Finally, the present invention also provides for a method of manufacturing a trim panel assembly comprising providing a mold assembly having a first cavity and a second cavity and a mold element movable between a first position to expose the second cavity and a second position to obstruct the cavity. With the mold element in the first position a first material is inserted into the first cavity and the second cavity to form a first trim component, which is then removed from the mold assembly. The mold element can be moved to the second position and either the first material or a second material is inserted into the first cavity to form a second trim component having a recess. The second trim component is removed from the mold assembly and a third trim component is inserted within the recess.

The system and methods for manufacturing a trim panel assembly of the present invention are advantageous over such conventional systems and methods in that the present invention permits the use of a single mold to produce a trim panel assembly having a hard trim panel with an insert that is either: 1) hard and the same color as the trim panel; 2) hard and a different color than the trim panel; or 3) soft and either the same or different color than the trim panel. Current such methods and systems do not permit the manufacture of a hard trim panel having a cloth or vinyl covered insert.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF DRAWINGS

The present invention will become more fully understood from the detailed description and the accompanying drawings, wherein:

FIG. 1A is an exploded perspective view of a vehicle door assembly incorporating a trim panel assembly manufactured according to an embodiment of the invention;

FIG. 1B is an exploded perspective view of a trim panel of the trim panel assembly and the use of a heat staking device to secure a bolster front-loaded within a recess of the trim panel;

FIG. 2 is a cross sectional view of a mold assembly illustrated according to a first embodiment of the present invention, the mold assembly having a core positioned in a first position;

FIG. 3 is a cross-sectional view of the mold assembly of FIG. 2, taken along line 3-3 of FIG. 2;

FIG. 4 is a cross sectional view of the mold assembly of FIG. 2, the core moved to a second position;

FIG. 5 is a cross sectional view of the mold assembly of FIG. 2 illustrating the core positioned in the first position, the mold assembly containing a first material and a second material;

FIG. 6 is a cross-sectional view of the mold illustrated in FIG. 5, taken along line 6-6 of FIG. 5;

FIG. 7 is an exploded cross sectional view of the use of a heat staking device to secure the bolster when rear-loaded within an aperture of the trim panel produced using the mold of FIG. 2;

FIG. 8 is a cross sectional view of the mold assembly of FIG. 2 having a plurality of inserts;

FIG. 9 is a cross sectional view of a mold assembly in accordance with an additional embodiment of the present invention;

FIG. 10 is a cross sectional view of a first vehicle trim panel manufactured using the mold assembly of FIG. 8;

FIG. 11A is an exploded cross sectional view of the use of a heat staking device to secure the bolster within a recess of the trim panel produced using the mold of FIG. 9; and

FIG. 11B is a cross sectional view of a second vehicle trim panel manufactured using the mold assembly of FIG. 9.

### DETAILED DESCRIPTION

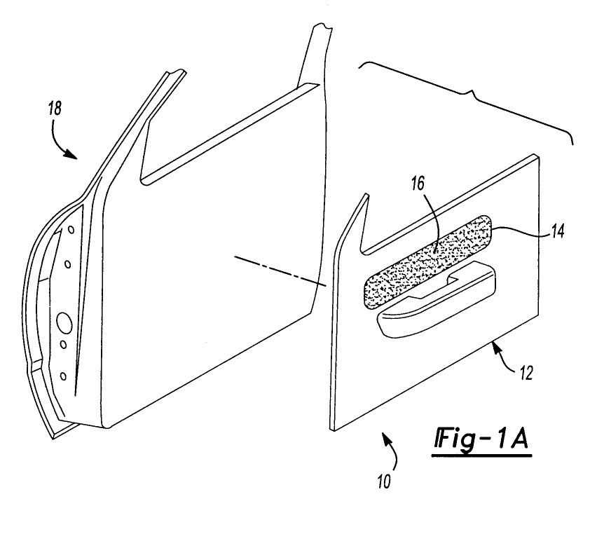

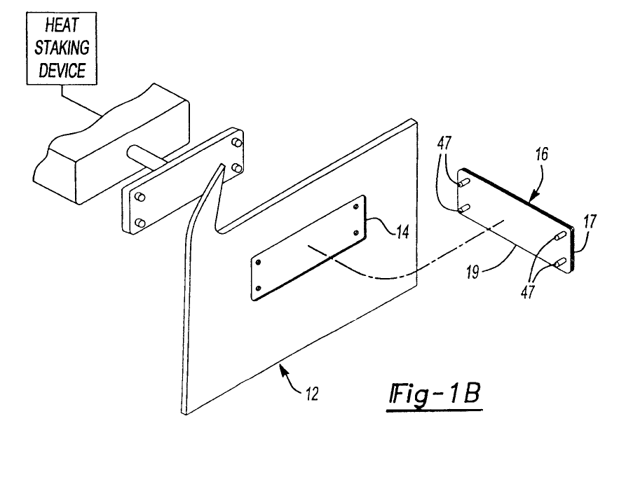

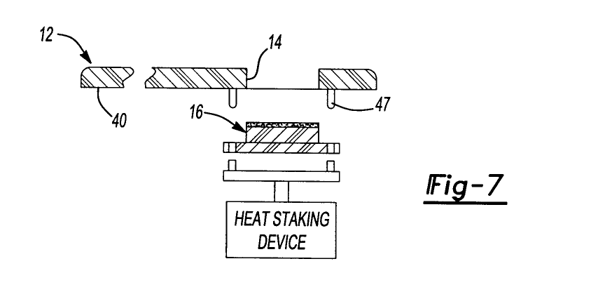

The following description of the preferred embodiments is merely exemplary in nature and is in no way intended to limit the invention, its application, or uses. FIG. 1 generally illustrates a vehicle trim panel assembly at 10. Trim panel assembly 10 includes a trim component or trim panel 12 having an optional receptacle, such as a recess 14. While FIG. 1B illustrates the receptacle as recess 14, the receptacle may also take the form of an aperture that extends entirely through panel 12, as illustrated in FIG. 7. An accent region or bolster 16 may be secured within recess 14 or recess 14 may be filled with a material that is the same as or different from the material of panel 12. Bolster 16 may be front loaded within panel 12 (FIG. 1B) or bolster 16 may be rear loaded within panel 12 (FIG. 7).

Panel 12 is preferably an automotive door trim panel 12 that mounts to a vehicle door assembly, generally shown at 18. Trim panel 12, is attached to vehicle door assembly 18 by one or more suitable fastening devices, such as polymeric Christmas Tree retainers (not shown) or by using other suitable fastening devices. It will be appreciated that trim panel 12 of the subject invention may be any type of trim panel or component. For example, other types of trim panels include trunk trim panels, polymeric quarter panels, rear package trays, headliners, instrument panels, garnish moldings, and console panels, among others.

Door trim panel 12 is preferably formed of a molded, hard polymeric material, such as polypropylene. As appreciated by those skilled in the art, trim panel 12 may be fabricated from other materials, such as resinated wood fibers, polyurethane, solid molded vinyl, expanded polyurethane foam, any combination thereof, or any other suitable rigid, electrically non-conductive material. Bolster 16 is preferably comprised of a substrate covered with a suitable cover-stock. For example, the substrate may be comprised of a polymer, wood, natural fibers, sheet reinforced injection molding (SRIM), or reinforced reaction injection molding (RRIM). The cover-stock may be comprised of cloth, vinyl, TPL, TPE, leather, or urethane. The cover-stock may also comprise a bi-laminate with a foam, cloth, woven, or non-woven backing. Finally, the bolster 16 may include a scrim.

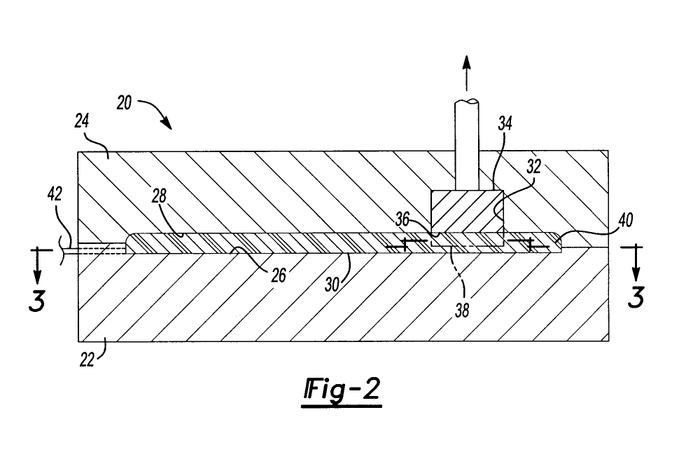

With reference to FIG. 2, a mold assembly for fabricating panel 12 is illustrated according to an embodiment of the present invention at 20. Mold assembly 20 includes a first mold half 22 and a second mold half 24. First mold half 22 includes a first mold surface 26, and second mold half 24 includes a second mold surface 28. Mold surfaces 26 and 28 may be of any desired shape and contour. For example, first mold surface 26 may be a mold core and second mold surface 28 may be a corresponding mold cavity. First mold half 22 and second mold half 24 are preferably mounted to platens (not shown) of a press (not shown), such as a vertical molding press of sufficient tonnage. When in the closed position, as shown in FIG. 2, first mold half 22 and second mold half 24 form a first cavity 30.

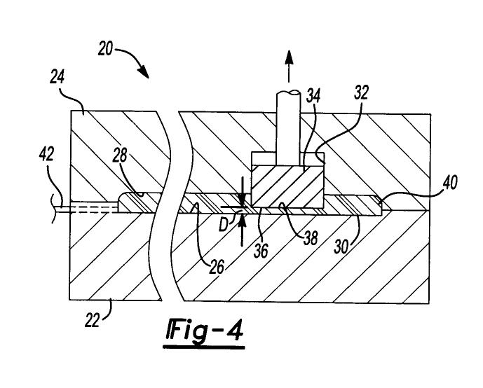

Second mold half 24 includes a core cavity 32 for slidably receiving a movable mold element or core 34. Movable core 34 includes a third mold surface 36, and is movable between a first position, as shown in FIG. 2, and a second position, as shown in FIG. 4. The mold surface 36 may be generally planar as shown, or may be of various different shapes and include various different surface features to form corresponding shapes and features within the panel 12. With core 34 at the first position, third mold surface 36 defines a portion of second mold surface 28, thereby substantially exposing a second cavity 38 (FIGS. 2 through 5). When in the second position (FIG. 4), core 34 substantially fills second cavity 38, resulting in the formation of recess 14.

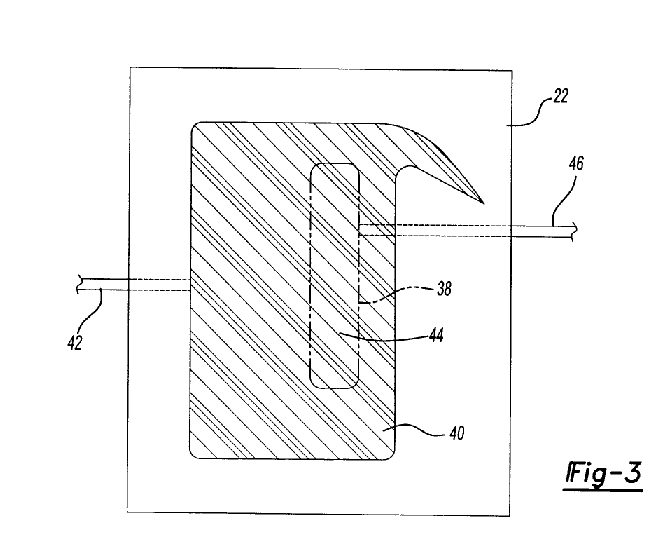

FIGS. 2 and 3 illustrate use of the mold 20 to fabricate panel 12 without recess 14. To fabricate panel 12 without recess 14, core 34 is moved to the first position (FIG. 2) and a first material 40 is introduced into mold 20 through a first passage 42. First material 40 substantially fills both first cavity 30 and second cavity 38. Preferably, first material 40 is a molten polymer, such as polypropylene. As first material 40 hardens, it conforms to the shape of first cavity 30 and second cavity 38, thereby forming trim panel 12 comprised of a single material and without recess 14 because core 34 does not obstruct second cavity 38 when in the first position. Panel 12 is next removed from mold 20, using any suitable method or device, and is secured to door assembly 18.

To provide panel 12 with recess 14, core 34 is moved to the second position, as shown in FIG. 4, before any material is injected within first cavity 30. When in the second position, core 34 is placed at a distance d from first surface 26 to substantially obstruct second cavity 38. Preferably, distance d is any desired distance greater than zero, the depth of recess 14 being directly proportionate to the distance d.

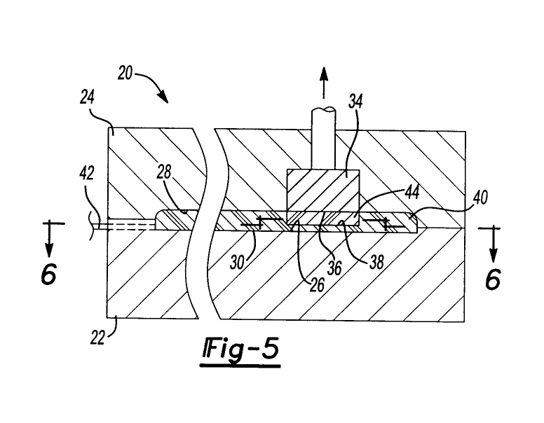

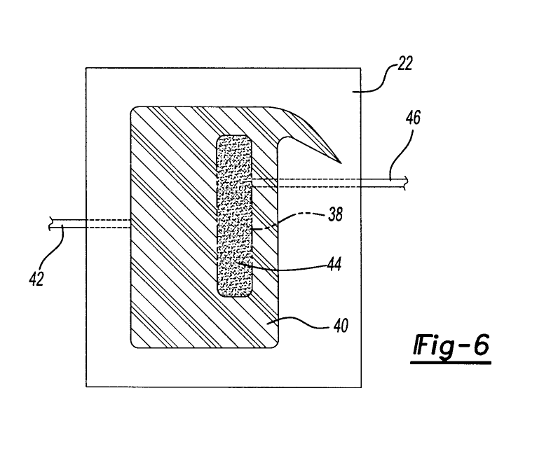

With core 34 in the second position, a material is injected through first passage 42. The material may be first material 40 or a different material. Preferably, the material is first material 40, and is a molten polymer, such as polypropylene. After first material 40 hardens, core 34 is moved to the first position (FIG. 5), thereby exposing second cavity 38. A second material 44 may be inserted within second cavity 38 through a second passage 45 to substantially fill second cavity 38 (FIG. 6). Second material 44 may be a hard material that is the same color as the first material 40, a hard material that is a different color than first material 40, or a soft material, other than a cloth or vinyl material, that has the same or different color than first material 40. After second material 44 hardens, first panel 12 is removed from the mold and secured to the door assembly 18 using any suitable method or device, such as molded oak features, polymeric Christmas tree fasteners, or the like.

The cloth or vinyl bolster 16 may be front-loaded within recess 14 in place of the second material 44 (as illustrated in FIG. 1B). In order to manufacture panel 12 with recess 14 free of second material 44, panel 12 is removed from mold 20 after first material 40 hardens and before the introduction of second material 44. Because first material 40 is injected with core 34 in the second position, but second material 44 is never introduced into mold 20, recess 14 is formed within panel 12 free of second material 44, permitting recess 14 to receive bolster 16.

Bolster 16 is manufactured apart from mold assembly 20 using any suitable device or method. Bolster 16 is preferably made of, or at least covered with, a soft material, preferably cloth or vinyl. Bolster 16 may be of the same or different color then the first material 40. Bolster 16 is secured within recess 14 using a suitable device or suitable method, such as bendable metal toy tabs, heat staked polymeric pins, rivets, or the like. For example, heat stake bosses 47 may be secured to bolster 16 during its manufacture so that bolster 16 may be heat staked within recess 14. Thus, a solid, hard trim panel 12 having a front-loaded cloth or vinyl bolster 16 is hereby produced. An important aspect of the invention is that the same mold 20 may be used to manufacture trim panel 12 in which second cavity 38 is filled or in which second cavity 38 is empty, thus producing recess 14 for receiving bolster 16.

Mold 20 may also be used to manufacture panel 12 in which the receptacle is an aperture or through hole 14a. To form through hole 14a, the above process for forming panel 12 is used, however, in the second position core 34 brought into contact with surface 26 and the distance d is zero. Moving the core 34 to this position creates the aperture 14a as seen in FIG. 7 to permit bolster 16 to be rear-loaded within panel 12. Bolster 16 is secured within the aperture 14a using any suitable method or device, such as heat staking tabs 47 to the panel 12. Panel 12, incorporating front loaded bolster 16 seated within aperture 14a, is secured to door assembly in any suitable manner.

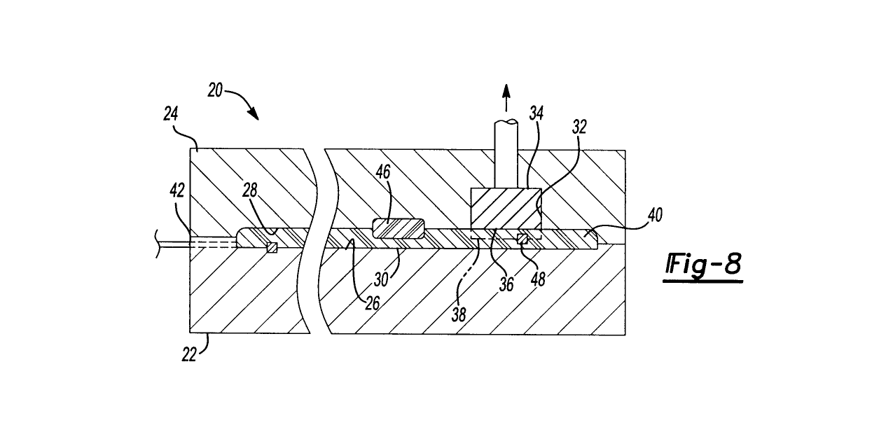

With reference to FIG. 8, a third material may be inserted within first cavity 30 of mold 20. The third material may be any suitable material, such as a first insert 46 or a second insert 48. Inserts 46 and 48 may be any suitable insert formed of a desired material, such as polypropylene or steel. Preferably, first insert 46 is relatively rigid having a decorative or ornamental surface. First insert 46 is preferably positioned within or adjacent to mold surface 28. Although only a single first insert 46 is illustrated in FIG. 8, any number of inserts 46 may be provided within trim panel 12.

Second insert 48 may be any type of insert, such as a fastener. Second insert 48 can be formed from any desired material, such as polypropylene or steel. Preferably, second insert 48 is positioned so that it is not visible to a vehicle occupant, such as within first material 40 or within, or adjacent to, mold surface 26. Although two second inserts 48 are illustrated in FIG. 8, any desired number of second inserts 48 may be incorporated within trim panel 12. The inserts can be a decorative piece, such as a wood grained or metallic trim piece or a functional piece, such as a fastener.

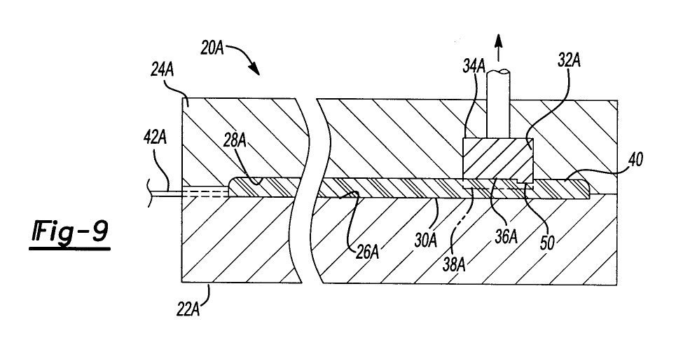

FIG. 9 illustrates a mold assembly according to an additional embodiment of the present invention at 20A. As mold assembly 20A is substantially similar to mold assembly 20, like reference numbers are used to identify common elements, with the elements of mold assembly 20A designated with the letter “A”. Further, because the common elements between mold 20 and mold 20A are fully described above in the description of mold 20, a complete description of these elements as they apply to mold 20A is not necessary.

Unlike mold assembly 20, mold assembly 20A includes a core 34A having a fourth mold surface 50. As illustrated in FIG. 9, when core 34A is placed in first position, third mold surface 36A defines a portion of second mold surface 28A, and fourth mold surface 50 obstructs a portion of second cavity 38A, shown in phantom line in FIG. 9. In the second position (not shown), core 34A is moved downward within core cavity 38A, such that both third mold surface 36A and forth mold surface 50 obstruct cavity 3 8A.

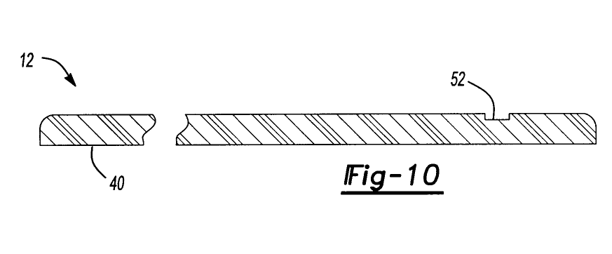

As illustrated in FIG. 10, when core 34A is positioned in first position, first material 40A, injected through first passage 42A, hardens to form a channel 52 within panel 12, the formation of channel 52 being caused by the penetration of fourth mold surface 50 within the second cavity 38A. The presence of the channel 52 within panel 12 has a variety of uses but is particularly desirable for attaching a decorative piece, such as a wood grained or metallic trim piece. After first material 40 hardens, panel 12 is removed from mold assembly 20A by any suitable method.

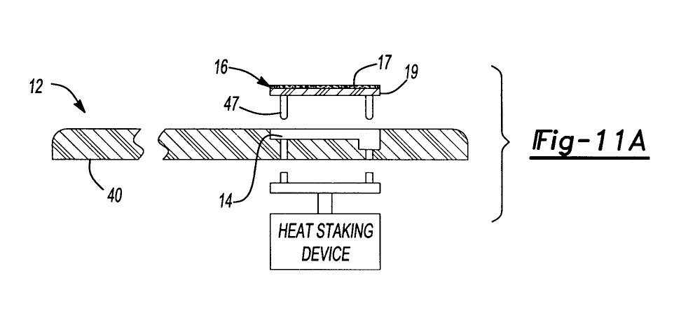

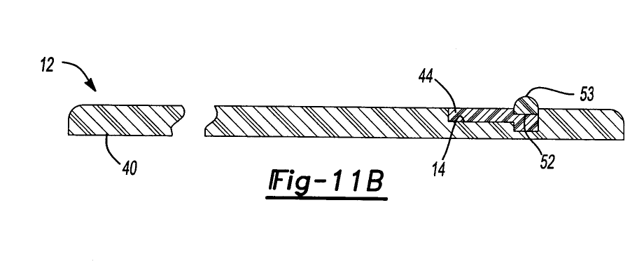

To produce panel 12 having both channel 52 and recess 14, core 34A is moved to the second position before material 40 is injected through first passage 42A. Specifically, the obstruction of second cavity 38A by third surface 36A and fourth surface 50 results in the formation of recess 14 and channel 52 when first material 40A hardens. Bolster 16 may then be secured within cavity 38A in any suitable manner, such as by heat staking tabs 47 to cavity 38A and channel 52 using a suitable heat staking device (FIG. 11A).

With reference to FIG. 11B, panel 12 may include a hard or soft material, other than cloth or vinyl, in place of bolster 16. Specifically, after first material 40 hardens within first cavity 30A, core 34A is raised to expose second cavity 38A and channel 52 formed within first material 40. Second material 44 is then injected through passage 42A (not shown) to fill both cavity 38A and at least a portion of channel 52 (FIG. 11). Further, a third material 53 may be placed within channel 52 over second material 44, the third material typically being a suitable decorative material. The resulting panel 12 is secured to the door assembly 18A in any suitable manner.

It is intended that the following claims cover the embodiments described above and any other departures from the disclosed embodiments that fall within the true spirit of this invention. The description of the invention is merely exemplary in nature and, thus, variations that do not depart from the gist of the invention are intended to be within the scope of the invention. Such variations are not to be regarded as a departure from the spirit and scope of the invention. claims

1. A method of manufacturing a trim panel assembly using a first tool having a mold cavity and a movable mold element to manufacture a first trim component and using a second tool to manufacture a second trim component comprising:
positioning the mold element such that the mold element at least substantially obstructs the mold cavity and inserting a first material in the cavity to form the first trim component having a receptacle resulting from the obstruction of the cavity by the element;
removing the first trim component from the first tool;
manufacturing a second trim component having a second material using a second tool that is different from the first tool; and
securing the second trim component within the receptacle.

2. The method of claim 1, wherein the second material comprises cloth.

3. The method of claim 1, wherein the second material comprises vinyl.

4. The method of claim 1, wherein the first material is substantially rigid.

5. The method of claim 1, wherein the receptacle is a recess.

6. The method of claim 1, wherein the receptacle is an aperture.

7. The method of claim 1, wherein the mold element has a first surface and a second surface extending from the first surface, the second surface obstructing the cavity to form a channel in the first material.

8. The method of claim 1, further comprising positioning an insert within the cavity to incorporate the insert within the trim component.

9. An automotive vehicle tooling system for manufacturing a trim panel assembly comprising:
a first tool operable to produce a first component of a first material, said first tool having a first cavity and a second cavity, said first tool further having a mold element movable between a first position to expose said second cavity and a second position to block said second cavity, said first tool receiving said first material and producing said panel having a receptacle when said mold element is positioned in said second position; and
a second tool different than said first tool operable to produce a second component having a second material different than said first material;
wherein said second component is secured within said receptacle of said first component.

10. The system of claim 9, further comprising:
positioning said mold element of said first tool in said first position;
introducing a third material into said first cavity and said second cavity to form a third trim component; and
removing said third trim component from said first tool.

11. The system of claim 9, wherein said receptacle is a recess.

12. The system of claim 9, wherein said receptacle is an aperture.

13. The system of claim 9, wherein said second component comprises cloth.

14. The system of claim 9, wherein said second component comprises vinyl.

15. The system of claim 9, wherein said first component comprises an insert.

16. An automotive trim panel assembly and a tooling system for producing the automotive trim panel comprising:
a first tool having a mold cavity and a mold element movable between a first position in which at least a majority of the mold element is positioned outside the cavity and a second position in which the element at least substantially obstructs the cavity;
a second tool assembly different from the first tool assembly;
manufacturing a first component of the trim panel assembly by inserting a first material within the first tool with the mold element in the second position to form a receptacle within said first component;
manufacturing a second component of the trim panel assembly using the second tool assembly and a second material; and
securing the second component within the receptacle of the first component.

17. The trim panel assembly and tooling system of claim 16, wherein said second material comprises cloth.

18. The assembly of claim 16, wherein said second material comprises vinyl.

19. The assembly of claim 16, wherein said receptacle is an aperture.

20. The assembly of claim 16, wherein said receptacle is a recess.
